(19) United States
(12) Patent Application Publication
(10) Pub. No.: US 2022/0397878 A1
(43) Pub. Date: Dec. 15, 2022

(54) CONTROL APPARATUS, CONTROL METHOD, AND NON-TRANSITORY COMPUTER-READABLE RECORDING MEDIUM

(71) Applicant: Mitsubishi Electric Corporation, Tokyo (JP)

(72) Inventors: Kazuki HAMADA, Tokyo (JP); Natsumi TAMURA, Tokyo (JP)

(73) Assignee: Mitsubishi Electric Corporation, Tokyo (JP)

(21) Appl. No.: 17/892,414

(22) Filed: Aug. 22, 2022

Related U.S. Application Data
(63) Continuation of application No. PCT/JP2020/011656, filed on Mar. 17, 2020.

(51) Int. Cl. G05B 19/042

(52) U.S. Cl. CPC G05B 19/042; G05B 2219/2614

(57) ABSTRACT

A control apparatus (100) includes a user zone estimation unit (120) and a system control unit (130). The user zone estimation unit (120) receives user position information indicating a position in an air-conditioning zone where an air-conditioner performs air-conditioning, at which one of at least one user who utilizes the air-conditioner has stayed; estimates a user zone with using the user position information, the user zone being a zone within the air-conditioning zone and including a plurality of positions at which one of said at least one user has stayed; and generates user zone information indicating the user zone. The system control unit (130) generates, with using the user zone information, system control information used for controlling an air-conditioning system having the air-conditioner.

### CROSS REFERENCE TO RELATED APPLICATIONS

This application is a Continuation of PCT International Application No. PCT/JP2020/011656 filed on Mar. 17, 2020, which is hereby expressly incorporated by reference into the present application.

### TECHNICAL FIELD

The present disclosure relates to a control apparatus, a control method, and a control program.

### BACKGROUND ART

A technique is known that detects, with a sensor, a zone where a person is present within a certain zone without specifying the person, and that controls an air-conditioner or the like depending on whether a person is present in the zone or not.

Patent Literature 1 discloses a technique that detects, with using an infrared sensor that detects a thermal image, a zone where a person is present without specifying the person.

### CITATION LIST

### Patent Literature

Patent Literature 1: JP 2018-204921 A

### SUMMARY OF INVENTION

### Technical Problem

According to the technique of Patent Literature 1, it is not possible to specify a user zone including a plurality of positions at which a user may stay, and to control an air-conditioner depending on whether a zone is a user zone or not.

An objective of the present disclosure is to estimate, within a zone where an air-conditioner performs air-conditioning, a user zone including a plurality of positions at which a user has stayed, and to generate information for controlling an air-conditioning system having the air-conditioner depending on whether a zone is a user zone or not.

### Solution to Problem

A control apparatus according to the present disclosure includes:

a user zone estimation unit to receive user position information indicating a position in an air-conditioning zone where an air-conditioner performs air-conditioning, at which one of at least one user who utilizes the air-conditioner has stayed; to estimate a user zone with using the user position information, the user zone being a zone within the air-conditioning zone and including a plurality of positions at which one of said at least one user has stayed; and to generate user zone information indicating the user zone; and

a system control unit to generate, with using the user zone information, system control information used for controlling an air-conditioning system having the air-conditioner.

### Advantageous Effects of Invention

A control apparatus 100 according to the present disclosure includes a user zone estimation unit 120 and a system control unit 130. The user zone estimation unit 120 estimates a user zone 92 including a plurality of positions at which a user who utilizes an air-conditioner 310 has stayed. The system control unit 130 generates, with using information indicating the user zone 92, system control information to be used for controlling an air-conditioning system 300 having the air-conditioner 310.

Therefore, with the control apparatus 100 according to the present disclosure, it is possible to estimate, within a zone where the air-conditioner 310 performs air-conditioning, the user zone 92 including the plurality of positions at which the user has stayed, and to generate information for controlling the air-conditioning system 300 having the air-conditioner 310, depending on whether a zone is a user zone 92 or not.

### BRIEF DESCRIPTION OF DRAWINGS

FIG. 1 illustrates a configuration example of a control apparatus 100 according to Embodiment 1.

FIG. 2 illustrates an example of a room provided with an air-conditioner 310.

FIG. 3 illustrates an example of a user zone 92 according to Embodiment 1.

FIG. 4 illustrates a hardware configuration example of the control apparatus 100 according to Embodiment 1.

FIG. 5 is a flowchart illustrating operations of the control apparatus 100 and operations of a sensor 200 according to Embodiment 1.

FIG. 6 illustrates a hardware configuration example of a control apparatus 100 according to a modification of the Embodiment 1.

FIG. 7 illustrates a configuration example of a control apparatus 100 according to Embodiment 2.

FIG. 8 illustrates a hardware configuration example of the control apparatus 100 according to Embodiment 2.

FIG. 9 is a flowchart illustrating operations of the control apparatus 100, operations of a sensor 200, and operations of a communication device 500 according to Embodiment 2.

FIG. 10 is a diagram explaining the operations of the control apparatus 100 according to Embodiment 2.

FIG. 11 is a diagram explaining operations of a control apparatus 100 according to Embodiment 3.

### DESCRIPTION OF EMBODIMENTS

In description and drawings of embodiments, the same elements and equivalent elements are denoted by the same reference sign. A description of an element denoted by the same reference sign will be appropriately omitted or simplified. Arrows in the drawings mainly indicate data flows or process flows.

### Embodiment 1

The present embodiment will be described in detail with referring to drawings.

***Description of Configurations***

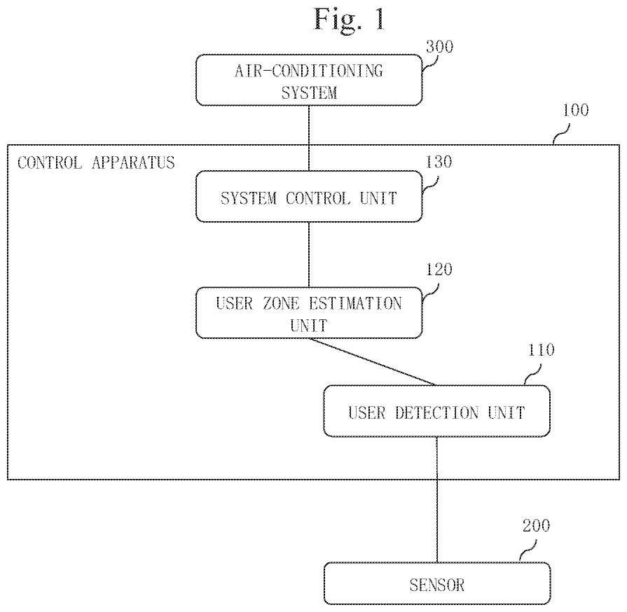

FIG. 1 illustrates a configuration example of a control apparatus 100 according to the present embodiment. As illustrated in FIG. 1, the control apparatus 100 is provided with a user detection unit 110, a user zone estimation unit 120, and a system control unit 130.

The control apparatus 100 is connected to a sensor 200 and an air-conditioning system 300.

The user detection unit 110 receives data from the sensor 200 and analyzes the received data to generate user position information. The user position information indicates a position at which at least one user has stayed. The position at which the user has stayed may include a position at which a user is anticipated to stay. The user utilizes the air-conditioning system 300. The user is not limited to a human being but may be an animal or a robot. A sum of users is at least 1. Unless otherwise noted, an expression “user” refers to one user included in at least one user.

Upon reception of the user information from the sensor 200, the user detection unit 110 transfers the received user position information to the user zone estimation unit 120.

The user zone estimation unit 120 receives the user position information. An air-conditioning zone 90 is a zone where an air-conditioner 310 performs air-conditioning.

The user zone estimation unit 120 estimates a user zone 92 with using the user position information. The user zone 92 is a zone within the air-conditioning zone 90 and including a plurality of positions at which one of at least one user has stayed. The position may be a zone having an area. The user zone 92 need not include all positions at which a user has stayed. The user zone 92 may be a zone including an ordinary behavior range of the user. A specific example of the ordinary behavior range of the user is a zone into which the user is likely to step into on a daily basis, or is a zone where a frequency with which a user stays is not excessively low. A user does not often stay, or does not stay in a zone other than the user zone 92.

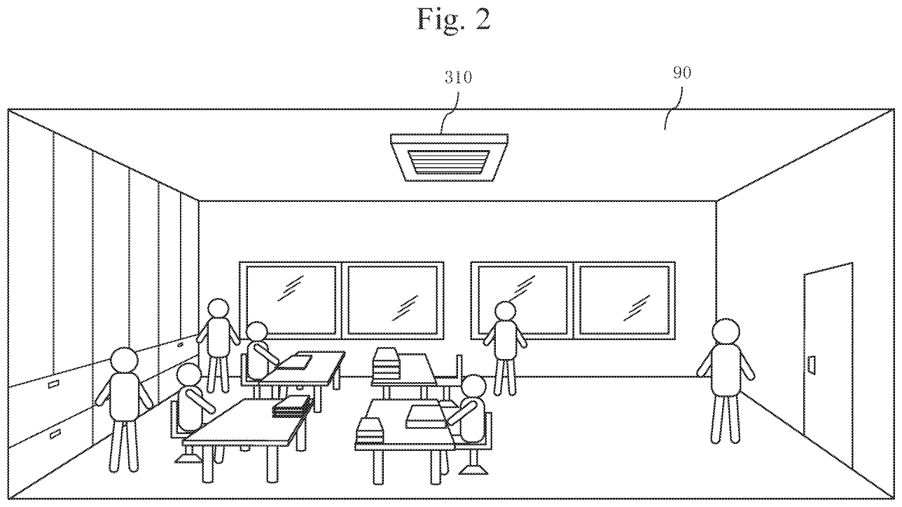

FIG. 2 illustrates an example of a room provided with the air-conditioner 310. FIG. 2 depicts an office room.

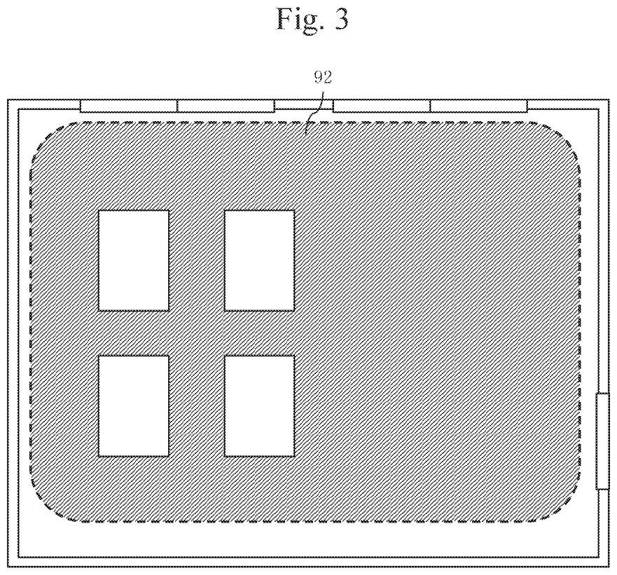

FIG. 3 illustrates an example of the user zone 92. FIG. 3 is a plan view of the room illustrated in FIG. 2. In FIG. 3, an example of the user zone 92 is indicated with hatched lines. In FIG. 3, the user zone 92 does not include zones where desks are installed, zones near a wall, and the like, because a user does not step into these zones often.

The system control unit 130 generates system control information with using user zone information. The user zone information indicates the user zone 92. The system control information is used for controlling the air-conditioning system 300.

The sensor 200 acquires data used for detecting a user. A specific example of the sensor 200 is a thermal image sensor, a human sensor, or an image sensor. The sensor 200 may be constituted of a plurality of types of sensors. The sensor 200 may detect a user by analyzing the data acquired by the sensor 200. The sensor 200 may generate the user position information.

The sensor 200 scans a scanning zone 91 and acquires a scanning result. The scanning zone 91 is a zone within the air-conditioning zone 90. The scanning result is a result obtained by the sensor 200 through scanning the scanning zone 91. The scanning result includes the data acquired in the scanning zone 91 by the sensor 200. The scanning result may include the user position information.

The air-conditioning system 300 has the air-conditioner 310. The air-conditioner 310 performs air-conditioning in the air-conditioning zone 90. Air-conditioning includes adjusting a state of air. In a specific example, the air-conditioner 310 can adjust temperature, humidity, or an amount of fine particles in air. The air-conditioner 310 may be an air cleaner, a dehumidifier, or a refrigerator employed in a large cold room.

At least two out of the control apparatus 100, the sensor 200, and the air-conditioning system 300 may be formed integrally.

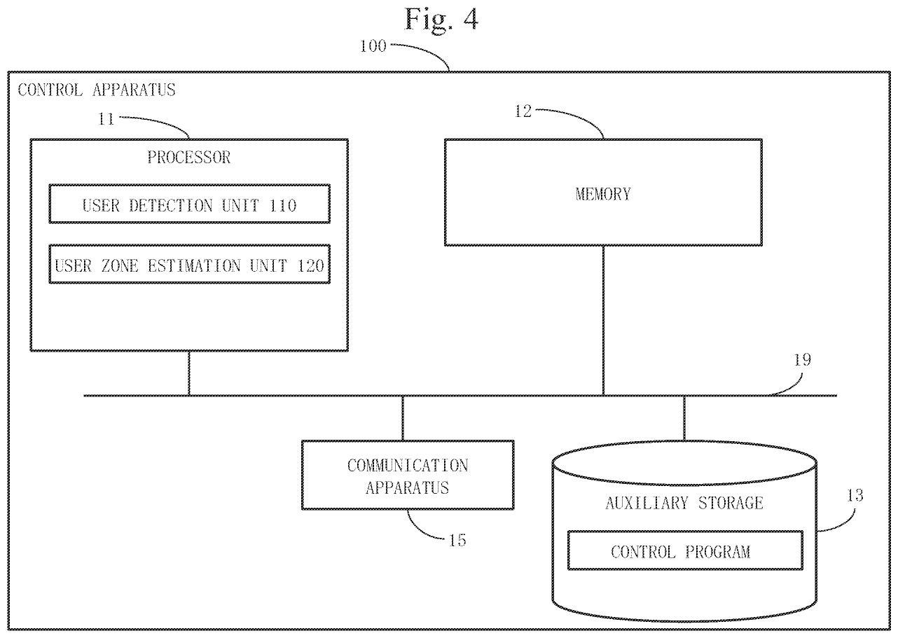

FIG. 4 illustrates a hardware configuration example of the control apparatus 100 according to the present embodiment. The control apparatus 100 is formed of a computer 10. The control apparatus 100 may be formed of a plurality of computers 10.

The computer 10 is a computer provided with hardware devices such as a processor 11, a memory 12, an auxiliary storage 13, and a communication apparatus 15, as illustrated in FIG. 4. These hardware devices are connected to each other via a signal line 19.

The processor 11 is an Integrated Circuit (IC) which performs arithmetic processing, and controls the hardware devices provided to the computer. A specific example of the processor 11 is a microcomputer, a Central Processing Unit (CPU), a Digital Signal Processor (DSP), or a Graphics Processing Unit (GPU).

The control apparatus 100 may be provided with a plurality of processors that substitute for the processor 11. The plurality of processors share roles of the processor 11.

The memory 12 is typically a volatile storage. The memory 12 is also called a main storage or a main memory. A specific example of the memory 12 is a Random-Access Memory (RAM). Data stored in the memory 12 is saved in the auxiliary storage 13 as necessary.

The auxiliary storage 13 is typically a non-volatile storage. A specific example of the auxiliary storage 13 is a Read-Only Memory (ROM), a Hard Disk Drive (HDD), or a flash memory. The data stored in the auxiliary storage 13 is loaded to the memory 12 as necessary.

The memory 12 and the auxiliary storage 13 may be formed integrally.

The communication apparatus 15 is a receiver/transmitter. A specific example of the communication apparatus 15 is a communication chip or a Network Interface Card (NIC). The control apparatus 100 may be provided with a plurality of types of communication apparatuses 15.

Each unit in the control apparatus 100 uses the communication apparatus 15 when communicating with the sensor 200 or the air-conditioning system 300.

A control program is stored in the auxiliary storage 13. The control program is a program that causes the computer to implement functions of the units provided to the control apparatus 100. The control program may be formed of a plurality of files. The control program is loaded to the memory 12 and run by the processor 11. Functions of the units provided to the control apparatus 100 are implemented by software.

Data used when running the control program, data obtained by running the control program, and so on are stored in the storage properly. In a specific example, the storage is formed of at least one out of the memory 12, the auxiliary storage 13, a register in the processor 11, and a cache memory in the processor 11. Note that data and information may have the same meaning. The storage may be independent of the computer 10.

The function of the memory 12 and the function of the auxiliary storage 13 may be implemented by different storages separately.

The control program may be recorded in a computer-readable non-volatile recording medium. A specific example of the non-volatile recording medium is an optical disk or a flash memory. The control program may be provided in the form of a program product.

***Description of Operations***

An operation procedure of the control apparatus 100 corresponds to a control method. A program that implements operations of the control apparatus 100 corresponds to the control program.

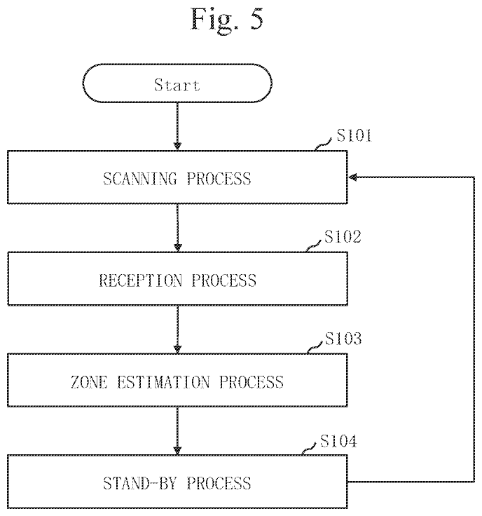

FIG. 5 is a flowchart illustrating an example of the operations of the control apparatus 100 and operations of the sensor 200. The operations of the control apparatus 100 will be described with referring to FIG. 5.

(Step S101: Scanning Process)

The sensor 200 scans the scanning zone 91 and transmits the scanning result to the control apparatus 100. The scanning zone 91 is a zone within the air-conditioning zone 90, which is to be scanned by the sensor 200. The sensor 200 acquires data corresponding to the scanning zone 91.

The sensor 200 need not always scan the same scanning zone 91.

The user detection unit 110 may instruct the sensor 200 to scan the scanning zone 91.

(Step S102: Reception Process)

The user detection unit 110 receives the scanning result from the sensor 200 and generates the user position information with using the received scanning result.

(Step S103: Zone Estimation Process) The user zone estimation unit 120 estimates the user zone 92 with using the user position information. In a specific example, the user zone estimation unit 120 detects a user from a plurality of scanning results. The user zone estimation unit 120 treats a zone where a frequency with which a user is detected is relatively high, as the user zone 92.

The user zone estimation unit 120 may include a periphery of the zone where a user is detected, into the user zone 92. The user zone estimation unit 120 may treat a zone between a plurality of points at each of which a user is detected, as a user zone 92.

(Step S104: Stand-by Process)

The control apparatus 100 stands by for a predetermined period of time and then proceeds to step S101. The predetermined period of time does not always have the same duration.

The system control unit 130 generates system control information with using information of the user zone 92 and transmits the system control information to the air-conditioning system 300. The user zone 92 is estimated by the process of the flowchart mentioned above. The air-conditioning system 300 controls the air-conditioning system 300 with using the system control information. A specific example of the system control information is to hit the user zone 92 with air, not to hit to the user zone 92 with air, or to change blow-out temperature, wind speed, or the like between the user zone 92 and portions other than the user zone 92.

The system control unit 130 may generate the system control information at any timing. The system control unit 130 may generate the system control information with using room temperature, room humidity, or the like.

***Description of Effect of Embodiment 1***

As described above, according to the present embodiment, the user zone estimation unit 120 estimates the user zone 92. The user zone 92 includes a position at which a user has stayed. The system control unit 130 generates the system control information with using the user zone 92 and transmits the system control information to the air-conditioning system 300. The air-conditioning system 300 controls the air-conditioning system 300 with using the system control information.

Hence, by using the system control information generated by the control apparatus 100 according to the present embodiment, the air-conditioning system 300 can perform control differently between a zone where a user stays and a zone where a user does not stay.

***Other Configurations***

<Modification 1>

A user zone estimation unit 120 may calculate a user zone 92 in accordance with a layout of a room where an air-conditioner 310 is installed.

In a specific example of the present modification, a user zone estimation unit 120 detects a floor in the air-conditioning zone 90, finds heights of points in a room from the floor and does not include in the user zone 92 a zone higher than the floor by a predetermined value or more.

In another specific example, when calculating the user zone 92, the user zone estimation unit 120 uses room layout data stored in a storage.

<Modification 2>

A user zone estimation unit 120 may divide a user zone 92 into a plurality of blocks and may calculate a probability that a user is present in each of the plurality of blocks.

In the present modification, a system control unit 130 may generate system control information indicating control in each of the plurality of blocks.

<Modification 3>

A control apparatus 100 may be constituted such that a user can decide a content of control for a user zone 92. In the present modification, the control apparatus 100 may be provided with an input interface 14. In a specific example, the input interface 14 is an infrared-ray sensor or an optical sensor.

In a specific example of the present modification, the user uses a remote controller to transmit to the control apparatus 100 a signal including the content of control for the user zone 92. A system control unit 130 generates system control information in accordance with the received signal.

<Modification 4>

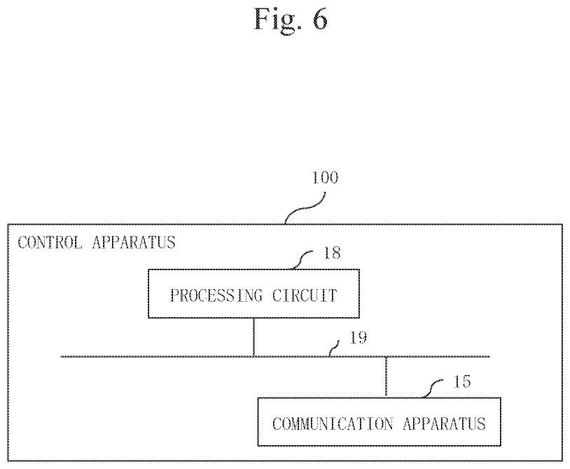

FIG. 6 illustrates a hardware configuration example of a control apparatus 100 according to the present modification.

As illustrated in FIG. 6, the control apparatus 100 is provided with a processing circuit 18 in place of at least one out of a processor 11, a memory 12, and an auxiliary storage 13.

The processing circuit 18 is hardware that implements at least some of units provided to the control apparatus 100.

The processing circuit 18 may be dedicated hardware, or may be a processor that runs a program stored in the memory 12.

If the processing circuit 18 is dedicated hardware, a specific example of the processing circuit 18 is a single circuit, a composite circuit, a programmed processor, a parallel-programmed processor, an Application Specific Integrated Circuit (ASIC), or a Field Programmable Gate Array (FPGA); or a combination of a single circuit, a composite circuit, a programmed processor, a parallel-programmed processor, an ASIC, and an FPGA.

The control apparatus 100 may be provided with a plurality of processing circuits that substitute for the processing circuit 18. The plurality of processing circuits share roles of the processing circuit 18.

In the control apparatus 100, some of functions may be implemented by dedicated hardware, and the remaining functions may be implemented by software or firmware.

In a specific example, the processing circuit 18 is implemented by hardware, software, or firmware; or a combination of hardware, software, and firmware.

The processor 11, the memory 12, the auxiliary storage 13, and the processing circuit 18 are collectively referred to as “processing circuitry”. That is, the functions of function components of the control apparatus 100 are implemented by processing circuitry.

A control apparatus 100 according to another embodiment may have the same configuration as that of the present modification.

### Embodiment 2

A difference from the embodiment described above will mainly be described below with referring to drawings. In the present embodiment, note that at least one user who utilizes an air-conditioner 310 each carries a communication device 500 to communicate with a control apparatus 100.

***Description of Configuration***

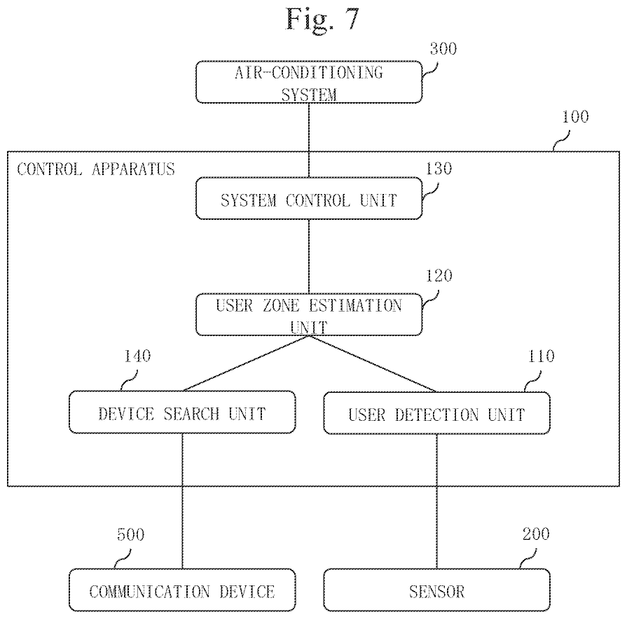

FIG. 7 illustrates a configuration example of the control apparatus 100 according to the present embodiment. As illustrated in FIG. 7, the control apparatus 100 is provided with a device search unit 140 in addition to a user detection unit 110, a user zone estimation unit 120, and a system control unit 130.

The device search unit 140 searches for the communication device 500 within a device search zone 93. The device search zone 93 is a zone within an air-conditioning zone 90, where the device search unit 140 searches for the communication device 500.

A brief description will be made on a specific example of operations of the device search unit 140 in a case where a user included in at least one user is present in the air-conditioning zone 90 as a search user, a sum of search users is 1 or more, and a communication device 500 carried by each search user is present in the device search zone 93.

In this case, first, the device search unit 140 transmits search information to inside the device search zone 93.

Subsequently, the device search unit 140 receives reply information from the communication device 500 carried by each search user, thereby searching for the communication device 500 carried by each search user. The device search unit 140 may treat the searched-for communication device 500, as a search communication device.

The user zone estimation unit 120 identifies a user-holding zone 94. The user-holding zone 94 is a zone within the air-conditioning zone 90, which is assigned to the user. The user-holding zone 94 is a subordinate concept to a user zone 92. The user-holding zone 94 may be a zone assigned to a search user, or may be a local zone. The local zone is part of the air-conditioning zone 90. The air-conditioning zone 90 is a zone where an air-conditioning system 300 adjusts a state of air. In a specific example, the air-conditioning zone 90 is a room where the air-conditioner 310 is installed. The user need not necessarily occupy the user-holding zone 94.

The user zone estimation unit 120 may find a local stay proportion. The local stay proportion is fixed per local zone and per user. The local stay proportion is a proportion of a time duration a user stays at a local zone to a conditioned-zone stay time duration of the user. The conditioned-zone stay time duration is a total time duration the user is staying at the air-conditioning zone 90. If the local stay proportion is equal to or higher than a predetermined value, the user zone estimation unit 120 may treat a local zone corresponding to the local stay proportion, as the user-holding zone 94 of a user corresponding to the local stay proportion.

The user zone estimation unit 120 may set a plurality of local zones in the air-conditioning zone 90. The plurality of local zones may overlap with each other. If the user zone estimation unit 120 sets a plurality of local zones, the user zone estimation unit 120 finds a local stay proportion corresponding to each of the plurality of local zones. The user zone estimation unit 120 finds a probability that the local stay proportion is equal to or higher than a predetermined value. When the found probability is equal to or higher than the predetermined value, the user zone estimation unit 120 may treat a local zone corresponding to the local stay proportion, as the user-holding zone 94.

In a specific example, the user-holding zone 94 is a work space assigned to the user. In a specific example, the work space is a zone corresponding to a seat assigned to a staff member in the office. In a specific example, the zone corresponding to the seat is a zone around a chair, or a zone occupied by a chair and a desk. When a seat is set in the air-conditioning zone 90, the user-holding zone 94 may be a zone corresponding to the seat.

The user zone estimation unit 120 may tie user position information corresponding to each search user and device discriminative information corresponding to each search communication device to each other, thereby generating device position information, may accumulate the generated device position information, and may treat the device position information that is accumulated, as accumulated position information. The user zone estimation unit 120 accumulates the device position information to a storage. The user zone estimation unit 120 may estimate the user-holding zone 94 as the user zone 92 with using the accumulated position information. Note that the user position information includes information corresponding to each search user. The information corresponding to each search user may be information employed when the user zone estimation unit 120 estimates a correspondence between one search user and the user position information, or may be information that is not presented explicitly. In a specific example, the information that is not presented explicitly is information found by taking a plurality of pieces of information into account.

When estimating the user-holding zone 94, the user zone estimation unit 120 may judge if a zone in the air-conditioning zone 90 is assigned to each search user or not, with using a user-holding condition. The user-holding condition is a condition for judging if a zone in the air-conditioning zone 90 is assigned to one of the search users or not.

A description will be made on an example of the user-holding condition in a case where the search users include a target user and the accumulated position information includes device position information in which the target user and a target zone in the air-conditioning zone 90 are tied to each other. The target user may be any user included in the search users. In a specific example of this case, if the user-holding condition is used, when a proportion of a total amount of device position information including target information, to a total amount of device position information, included in the accumulated position information and corresponding to the target user, is equal to or higher than a user-holding criterion, the user zone estimation unit 120 judges that the target zone is a zone assigned to the target user. The target information is information which is included in the accumulated position information and in which the target user and the target zone are tied to each other.

A sensor 200 may be a move eye (registered trademark).

The communication device 500 is a communication equipment carried by the user. The user and the communication device 500 carried by the user need not be in tight contact constantly with each other. A specific example of the communication device 500 is a smartphone or a wearable device.

A control application 510 is installed in the communication device 500. The control application 510 has a function of communicating with a search apparatus 16. In the present specification, an application refers to an application program unless otherwise noted.

The communication device 500 receives search information for searching for the communication device 500. The search information is used for search of the communication device 500. The communication device 500 transmits reply information to the control apparatus 100. The reply information is information corresponding to the search information and includes device discriminative information. The device discriminative information is information that discriminates the communication device 500 having transmitted the reply information.

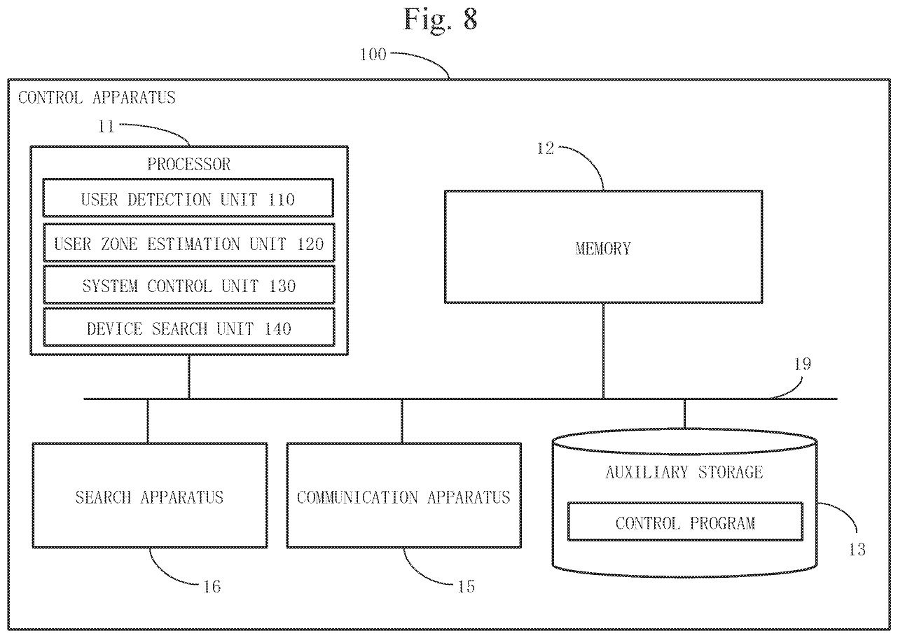

FIG. 8 illustrates a hardware configuration example of the control apparatus 100.

The control apparatus 100 is provided with the search apparatus 16, as illustrated in FIG. 8.

The search apparatus 16 implements at least some of functions of the device search unit 140. A specific example of the search apparatus 16 is a Bluetooth (registered trademark) Low Energy beacon.

The search apparatus 16 may be independent of a computer 10. In this case, the search apparatus 16 communicates with the computer 10. There may be a plurality of search apparatuses 16.

***Description of Operations***

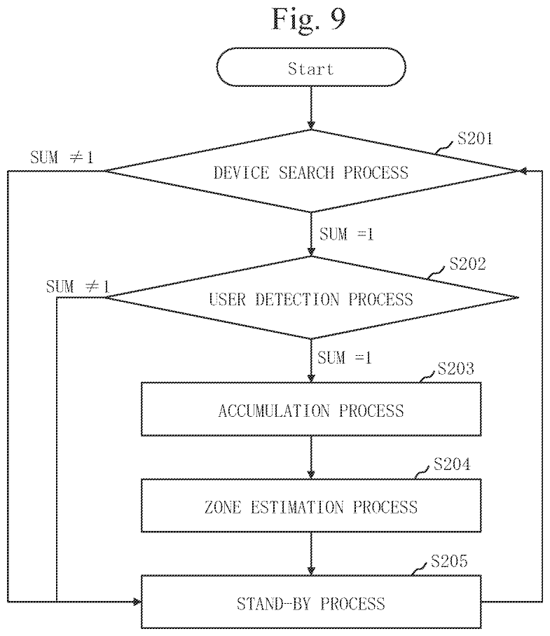

FIG. 9 is a flowchart illustrating an example of operations of the control apparatus 100, operations of the sensor 200, and operations of the communication device 500. The operations of the control apparatus 100 will be described with referring to FIG. 9.

(Step S201: Device Search Process)

The device search unit 140 transmits the search information to the air-conditioning zone 90, thereby searching for the communication device 500 present in the device search zone 93.

When the communication device 500 receives the search information, the control application 510 transmits the reply information to the device search unit 140.

In a specific example, if the search apparatus 16 is a Bluetooth (registered trademark) Low Energy beacon, the search information is advertising data.

The device search unit 140 finds a sum of communication devices 500 in the device search zone 93.

If the sum of communication devices 500 in the device search zone 93 is 1, the device search unit 140 generates device information, and the control apparatus 100 proceeds to step S202. The device information includes the device discriminative information.

Otherwise, the control apparatus 100 proceeds to step S205.

(Step S202: User Detection Process)

The sensor 200 scans a scanning zone 91 and transmits a scanning result to the control apparatus 100. The user detection unit 110 may instruct the sensor 200 to scan the scanning zone 91.

The user detection unit 110 receives the scanning result from the sensor 200 and estimates a sum of users in the air-conditioning zone 90 by using the scanning result.

If it is estimated that the sum of users in the air-conditioning zone 90 is 1, the user detection unit 110 generates user position information from the scanning result, and the control apparatus 100 proceeds to step S203. The user position information indicates a user found in this step and a position at which this user is present.

Otherwise, the control apparatus 100 proceeds to step S205.

(Step S203: Accumulation Process)

The user zone estimation unit 120 ties the device discriminative information and the user position information to each other, thereby generating the device position information, and accumulates the generated device position information as the accumulated position information. The user zone estimation unit 120 accumulates the accumulated position information to the storage. The device discriminative information is included in the device information generated in step S201. The user position information is generated in step S202. The device position information is information in which a position at which the user is present is tied to the communication device 500 carried by this user. The device position information may include information of a time point at which the information included in the device position information has been acquired.

(Step S204: Zone Estimation Process)

The user zone estimation unit 120 estimates the user-holding zone 94 as the user zone 92, with using the accumulated position information. If device position information corresponding to a certain user satisfies a predetermined condition, the user zone estimation unit 120 treats a zone included in the user position information that matches the device position information, as the user-holding zone 94 corresponding to that user. The predetermined condition may also be called a user-holding condition. The user zone estimation unit 120 typically refers to the entire accumulated position information to judge if the predetermined condition is satisfied or not.

The predetermined condition will be described under an assumption that the user zone estimation unit 120 identifies a local zone L as the user-holding zone 94 corresponding to the target user. Assume that the target user and the communication device 500 possessed by the target user may be treated equally. Also assume that the target user possesses the same communication device 500 in a time range where data corresponding to the device position information was acquired.

A specific example of the predetermined condition is that: a proportion of a sum of target users detected in the local zone L to a sum of detected target users is equal to or higher than a predetermined threshold value; a target user is constantly detected in the local zone L within a time range T with a frequency equal to or higher than a predetermined value; or a target user is detected in the local zone L within a time frame U with a frequency equal to or higher than a predetermined value. The time range T and the time frame U are each a range defined by time from a start time point through an end time point. A difference between the end time point corresponding to the time range T and the start time point corresponding to the time range T falls within a predetermined range. Each of the start time point and the end time point corresponding to the time range T may be any time point. The start time point corresponding to the frame U falls within a predetermined range, and the end time point corresponding to the time frame U falls within a predetermined range.

If an amount of accumulated position information is not sufficient, the control apparatus 100 may proceed to step S205 without executing the above-mentioned process of step S204.

(Step S205: Stand-by Process)

A process of this step is the same as the process of step S104.

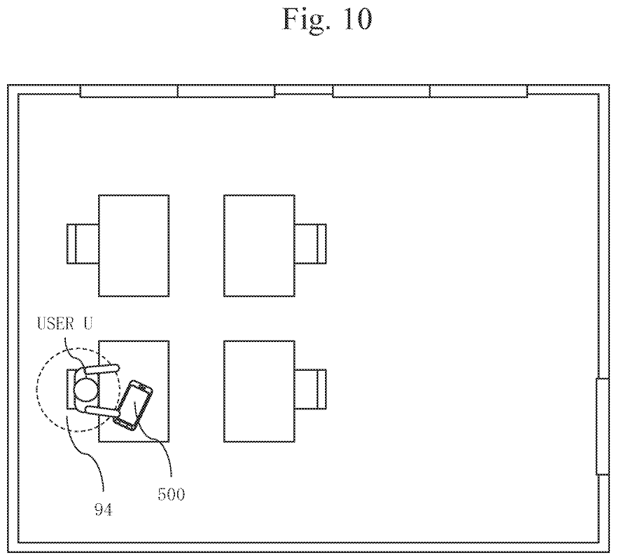

FIG. 10 is a diagram explaining an example of the operations of the control apparatus 100 according to the present embodiment.

Referring to FIG. 10, a sum of users in the air-conditioning zone 90 is 1, and a sum of communication device 500 in the air-conditioning zone 90 is 1.

In a situation illustrated in FIG. 10, the device search unit 140 generates device information corresponding to a communication device 500, and the user detection unit 110 generates user position information corresponding to a user U. If the user zone estimation unit 120 judges that a seat where the user U is present is assigned to the user U, the user zone estimation unit 120 estimates a zone corresponding to this seat as a user-holding zone 94.

A specific description will be made on the operations of the control apparatus 100 in a case where the search users are estimated to include only a first user and the sum of communication devices 500 possessed by the first user is 1. The first user may be any user included in the search users.

In this case, the device search unit 140 may search for the communication device 500 carried by the first user, as a first communication device.

In this case, the user zone estimation unit 120 may accept information corresponding to the first user and indicating a plurality of positions, as user position information, and may generate device position information with using the accepted user position information and device discriminative information which corresponds to the first communication device.

The system control unit 130 generates the system control information by using the user-holding zone 94. The user-holding zone 94 has been estimated by the process of the flowchart described above.

Operations of the system control unit 130 are the same as the operations of the system control unit 130 according to Embodiment 1.

***Description of Effect of Embodiment 2***

As described above, according to the present embodiment, the user zone estimation unit 120 can estimate the user-holding zone 94 per user, as the user zone 92, with using the device position information. The device position information is information in which the user position information and the device discriminative information are tied with each other.

The user-holding zone 94 may be a seat in an office or the like. Therefore, the control apparatus 100 can tie a user to a seat assigned to the user. Then, the system control unit 130 can generate control information with using an in-room status per user and information of a seat position per user. Therefore, the air-conditioning system 300 can control the air-conditioner 310 depending on whether the user is seated at the seat designated to him or her.

***Other Configurations***

<Modification 5>

A user zone estimation unit 120 may include seating data. The seating data includes information indicating positions of seats. The seating data may include information such as a seat layout and a seat size. In the present modification, the user zone estimation unit 120 estimates a seat of a user with using a seat position and a user position.

In the present modification, the user zone estimation unit 120 may estimate the seating data with using a scanning result.

The user zone estimation unit 120 may use seating data stored in a storage. When the user zone estimation unit 120 uses the seating data, in a specific example, the user zone estimation unit 120 treats a zone including a seat indicated by the seating data, as a local zone.

<Modification 6>

In step S203, a user zone estimation unit 120 may tie a plurality of pieces of device discriminative information and a plurality of pieces of user position information to each other.

In the present modification, the plurality of pieces of device discriminative information and the plurality of pieces of user position information may have been accumulated in a storage or in an external database.

<Modification 7>

A system control unit 130 may generate control information on the basis of a history of how a user has controlled an air-conditioning system 300.

In a specific example, the user controls an air-conditioner 310 with using a control application 510. The system control unit 130 accumulates the history of how the user has controlled the air-conditioner 310. The air-conditioning system 300 may transmit to a control apparatus 100 information including the history of how the user has controlled the air-conditioner 310.

In a specific example of the present modification, if a user U has performed control not to hit the user U with air, the system control unit 130 generates system control information corresponding to control of not to hit a user-holding zone 94 corresponding to the user U with air.

<Modification 8>

A control apparatus 100 may be adapted to a situation where one person has a plurality of communication devices 500.

In a specific example of the present modification, when a user U has been found, if a frequency with which a device A and a device B are found simultaneously is equal to or higher than a predetermined threshold value, a user zone estimation unit 120 judges that the user U possesses both of the device A and the device B. Note that the device A and the device B are each a communication device 500.

In the present modification, the control apparatus 100 may reverse the order of executing step S201 and step S202.

<Modification 9>

A control apparatus 100 may have a function of resetting a user-holding zone 94. In a specific example of the present modification, a user zone estimation unit 120 deletes a user-holding zone 94 stored in the user zone estimation unit 120. Assume that the user-holding zone 94 is stored in the user zone estimation unit 120. The user zone estimation unit 120 may store information indicating the user-holding zone 94, as user-holding zone information, and may delete user-holding zone information that is stored.

In the present modification, the user zone estimation unit 120 may reset the user-holding zone 94 periodically. The user zone estimation unit 120 may be triggered by a user operation to reset the user-holding zone 94.

In another specific example, when a local stay proportion corresponding to a situation where a user U stays at a user-holding zone 94 corresponding to the user U becomes equal to or lower than a predetermined threshold value, or when a local stay proportion corresponding to a situation where a user U stays at a local zone different from a user-holding zone 94 corresponding to the user U becomes equal to or higher than the predetermined threshold value, the user zone estimation unit 120 may reset the user-holding zone 94 automatically.

### Embodiment 3

A difference from Embodiment 2 will mainly be described below with referring to drawings.

The main difference between Embodiment 2 and Embodiment 3 resides in a condition under which a user and a communication device 500 are detected.

***Description of Configuration***

A configuration of a control apparatus 100 according to the present embodiment is the same as the configuration of the control apparatus 100 according to Embodiment 2.

***Description of Operations***

Operations of the control apparatus 100 according to the present embodiment are basically the same as the operations of the control apparatus 100 according to Embodiment 2. A difference between the two will mainly be described below.

In the present embodiment, the control apparatus 100 handles a case where there are a plurality of communication devices 500 in a device search zone 93, or a case where there are a plurality of users in a scanning zone 91.

(Step S201: Device Search Process)

A main difference between step S201 according to Embodiment 2 and step S201 according to the present embodiment resides in a process concerning a sum of communication devices 500 in the device search zone 93.

In this step, the control apparatus 100 alters a condition that the sum of communication devices 500 in the device search zone 93 is 1, to a condition that a sum of communication devices 500 that do not match a user-holding zone 94 in the device search zone 93 is 1.

A device search unit 140 generates device information corresponding to the communication device 500 that does not match the user-holding zone 94.

(Step S202: User Detection Process)

A main difference between step S202 according to Embodiment 2 and step S202 according to the present embodiment resides in a process concerning a sum of users in an air-conditioning zone 90.

In this step, the control apparatus 100 alters a condition that the sum of users in the air-conditioning zone 90 is estimated to be 1, to a condition that the sum of users that do not match the user-holding zone 94 in the air-conditioning zone 90 is estimated to be 1.

A user detection unit 110 generates user position information corresponding to a user that does not match the user-holding zone 94.

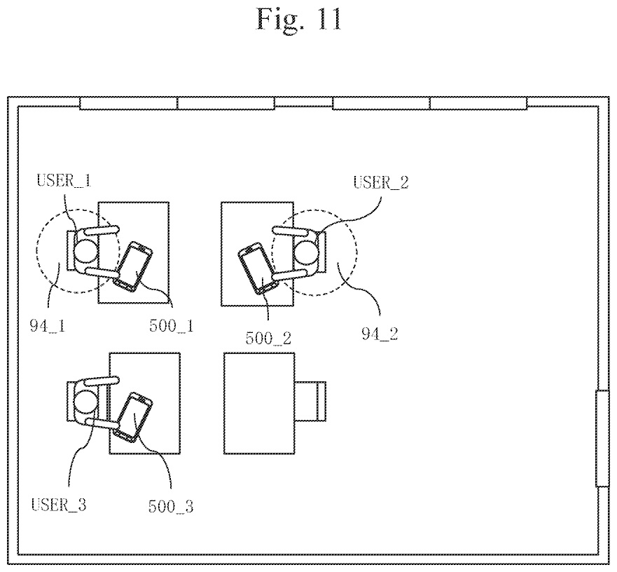

FIG. 11 is a diagram explaining the operations of the control apparatus 100 according to the present embodiment. In FIG. 11, a sum of users is 3, and a sum of communication devices 500 is 3. An expression “user_1” or the like is employed to distinguish a plurality of users and so on from each other. In FIG. 11, each of the user_1 and a communication device 500_1 matches a user-holding zone 94_1. Each of a user_2 and a communication device 500_2 matches a user-holding zone 94_2.

On the other hand, each of a user_3 and a communication device 500_3 does not match a user-holding zone 94.

In a situation illustrated in FIG. 11, the device search unit 140 finds the communication device 500_1, the communication device 500_2, and the communication device 500_3. The device search unit 140 confirms that only the communication device 500_3 does not match a user-holding zone 94, and generates device information corresponding to the communication device 500_3. The user detection unit 110 detects the user_1, the user_2, and the user_3. The user detection unit 110 confirms that only the user_3 does not match a user-holding zone 94, and generates user position information corresponding to the user_3. When a predetermined condition is satisfied, the user zone estimation unit 120 estimates a user-holding zone 94 corresponding to the user_3.

The operations of the control apparatus 100 in a case where a sum of search users is estimated to be 2 or more, the search users include a first user, and a sum of communication devices 500 carried by the first user is 1 will be described specifically.

In this case, when a first user assignment condition is satisfied, the device search unit 140 may search for the communication device 500 carried by the first user, as a first communication device. The first user assignment condition corresponds to a situation where there exist user-holding zones 94 being zones that match the other search users and match communication devices 500 carried by the other search users. The other search users are users included in the search users and excluding the first user.

In this case, when the first user assignment condition is satisfied, the user zone estimation unit 120 may accept information corresponding to the first user and indicating a plurality of positions, as user position information. The user zone estimation unit 120 may generate device position information with using the accepted user position information and device discriminative information which corresponds to the first communication device.

### Description of Effect of Embodiment 3

As described above, according to a specific example of the present embodiment, when a user U is present in the air-conditioning zone 90, even if another user is present in the air-conditioning zone 90, the control apparatus 100 can estimate the user-holding zone 94 corresponding to the user U.

### OTHER EMBODIMENTS

The embodiments described can be combined arbitrarily. Any component of each embodiment can be modified. Alternatively, in each embodiment, any component can be omitted.

Embodiments are not limited to Embodiments 1 to 3 described above, but various changes can be made to Embodiments 1 to 3. Procedures described with using flowcharts and so on may be changed as necessary.

### REFERENCE SIGNS LIST

10: computer; 11: processor; 12: memory; 13: auxiliary storage; 14: input interface; 15: communication apparatus; 16: search apparatus; 18: processing circuit; 19: signal line; 90: air-conditioning zone; 91: scanning zone; 92: user zone; 93: device search zone; 94: user-holding zone; 100: control apparatus; 110: user detection unit; 120: user zone estimation unit; 130: system control unit; 140: device search unit; 200: sensor; 300: air-conditioning system; 310: air-conditioner; 500: communication device; 510: control application.

1. A control apparatus comprising:
processing circuitry
to receive user position information indicating a position in an air-conditioning zone where an air-conditioner performs air-conditioning, at which one of at least one user who utilizes the air-conditioner stays; to estimate a user zone with using the user position information, the user zone being a zone within the air-conditioning zone and including a plurality of positions at which one of said at least one user has stayed; and to generate user zone information indicating the user zone; and
to generate, with using the user zone information, system control information used for controlling an air-conditioning system having the air-conditioner,
wherein the user position information is generated with using information acquired by a sensor through scanning a zone in the air-conditioning zone,
wherein said at least one user who utilizes the air-conditioner each carries a communication device to communicate with the control apparatus,
wherein the communication device receives search information for searching for the communication device and transmits reply information to the control apparatus, the reply information being information corresponding to the search information and including device discriminative information that discriminates the communication device, and
wherein the processing circuitry of the control apparatus, in a case where a user included in said at least one user is present in the air-conditioning zone as a search user, a sum of search users is 1 or more, and a communication device carried by each search user is present in a device search zone in the air-conditioning zone, further transmits the search information to inside the device search zone; and receives the reply information from the communication device carried by each search user, thereby searching for a communication device carried by each search user, and
ties user position information and the device discriminative information to each other, thereby generating device position information; accumulates the generated device position information; treats the device position information that is accumulated, as accumulated position information; and estimates a user-holding zone as the user zone with using the accumulated position information, the user-holding zone being a zone within the air-conditioning zone and assigned to the search user.

2. The control apparatus according to claim 1,
wherein when estimating the user-holding zone, the processing circuitry judges if a zone in the air-conditioning zone is assigned to each search user or not, with using a user-holding condition for judging if a zone in the air-conditioning zone is assigned to one of the search users or not.

3. The control apparatus according to claim 2,
wherein, in a case where the search users include a target user and the accumulated position information includes device position information in which the target user and a target zone in the air-conditioning zone are tied to each other,
the user holding-condition is a condition for judging that the target zone is a zone assigned to the target user, when a proportion of a total amount of device position information, included in the accumulated position information and including information in which the target user and the target zone are tied to each other, to a total amount of device position information, included in the accumulated position information and corresponding to the target user, is equal to or higher than a user-holding criterion.

4. The control apparatus according to claim 1,
wherein, in a case where the search users are estimated to include only a first user and a sum of communication devices possessed by the first user is 1,
the processing circuitry
searches for the communication device carried by the first user, as a first communication device, and
accepts information indicating a plurality of positions at which the first user has stayed, as the user position information, and generates the device position information with using the accepted user position information and device discriminative information which corresponds to the first communication device.

5. The control apparatus according to claim 4,
wherein, in a case where a sum of search users is estimated to be 2 or more; the search users include a first user; a first user assignment condition is satisfied, the first user assignment condition corresponding to a situation where a sum of communication devices carried by the first user is 1, there exist, as the user-holding zones, zones that match the other search users excluding the first user included in the search users, and match communication devices carried by the other search users; and each of the other search users is present in a user-holding zone corresponding to said each of the other search users,
the processing circuitry
searches for a communication device carried by the first user, as a first communication device, and
accepts information indicating a plurality of positions at which a user has stayed, the user being present outside the user-holding zones matching the other search users, as the user position information, and generates the device position information with using the accepted user position information and device discriminative information which corresponds to the first communication device.

6. The control apparatus according to claim 1,
wherein the processing circuitry stores information indicating the user-holding zone, as user-holding zone information, and deletes user-holding zone information that is stored.

7. The control apparatus according to claim 1,
wherein when a seat is set in the air-conditioning zone, the processing circuitry estimates that the zone corresponding to the seat is the user-holding zone.

8. A control method carried out by a control apparatus and comprising:
receiving user position information indicating a position in an air-conditioning zone where an air-conditioner performs air-conditioning, at which one of at least one user who utilizes the air-conditioner stays, estimating a user zone with using the user position information, the user zone being a zone within the air-conditioning zone and including a plurality of positions at which one of said at least one user has stayed, and generating user zone information indicating the user zone; and
generating, with using the user zone information, system control information used for controlling an air-conditioning system having the air-conditioner,
wherein the user position information is generated with using information acquired by a sensor through scanning a zone in the air-conditioning zone, wherein said at least one user who utilizes the air-conditioner each carries a communication device to communicate with the control apparatus,
wherein the communication device receives search information for searching for the communication device and transmits reply information to the control apparatus, the reply information being information corresponding to the search information and including device discriminative information that discriminates the communication device, and
wherein the control apparatus, in a case where a user included in said at least one user is present in the air-conditioning zone as a search user, a sum of search users is 1 or more, and a communication device carried by each search user is present in a device search zone in the air-conditioning zone, further transmits the search information to inside the device search zone; and receives the reply information from the communication device carried by each search user, thereby searching for a communication device carried by each search user, and
ties user position information and the device discriminative information to each other, thereby generating device position information; accumulates the generated device position information; treats the device position information that is accumulated, as accumulated position information; and estimates a user-holding zone as the user zone with using the accumulated position information, the user-holding zone being a zone within the air-conditioning zone and assigned to the search user.

9. A non-transitory computer-readable recording medium recorded with a control program which causes a computer being a control apparatus in which user position information is stored, the user position information indicating a position in an air-conditioning zone where an air-conditioner performs air-conditioning, at which one of at least one user who utilizes the air-conditioner stays,
to estimate a user zone with using the user position information, the user zone being a zone within the air-conditioning zone and including a plurality of positions at which one of said at least one user has stayed, and to generate user zone information indicating the user zone; and
to generate, with using the user zone information, system control information used for controlling an air-conditioning system having the air-conditioner,
wherein the user position information is generated with using information acquired by a sensor through scanning a zone in the air-conditioning zone,
wherein said at least one user who utilizes the air-conditioner each carries a communication device to communicate with the control apparatus,
wherein the communication device receives search information for searching for the communication device and transmits reply information to the control apparatus, the reply information being information corresponding to the search information and including device discriminative information that discriminates the communication device, and
wherein the control program, in a case where a user included in said at least one user is present in the air-conditioning zone as a search user, a sum of search users is 1 or more, and a communication device carried by each search user is present in a device search zone in the air-conditioning zone, further causes the computer to transmit the search information to inside the device search zone; and to receive the reply information from the communication device carried by each search user, thereby searching for a communication device carried by each search user, and
to tie user position information and the device discriminative information to each other, thereby generating device position information; to accumulate the generated device position information; to treat the device position information that is accumulated, as accumulated position information; and to estimate a user-holding zone as the user zone with using the accumulated position information, the user-holding zone being a zone within the air-conditioning zone and assigned to the search user.
